(19) United States
(12) Patent Application Publication
(10) Pub. No.: US 2026/0255452 A1
(43) Pub. Date: Aug. 27, 2026

(54) LED DRIVE CONTROL DEVICE AND CONTROL CIRCUIT

(71) Applicant: ROHM Co., Ltd., Kyoto (JP)

(72) Inventor: Hironori KONDO, Kyoto (JP)

(73) Assignee: ROHM Co., Ltd., Kyoto (JP)

(21) Appl. No.: 19/547,641

(22) Filed: Feb. 23, 2026

(30) Foreign Application Priority Data
Feb. 27, 2025 (JP) 2025-030187

(51) Int. Cl. H05B 45/10; H05B 45/325; H05B 47/16

(52) U.S. Cl. CPC H05B 45/10; H05B 45/325; H05B 47/16

(57) ABSTRACT

An LED drive control device includes: a clock setting unit, setting a first clock pulse count corresponding to a maximum bit number of dimming data; a clock generation unit, generating control clock pulses in which a pulse count in a predetermined cycle is a second clock pulse count smaller than the first clock pulse count; a dimming correction unit, correcting the dimming data based on the first and second clock pulse counts, and outputting dimming correction data; and a drive unit, supplying a drive current to the LED device during a period of counting the control clock pulses by a number of clock pulses of the dimming correction data in each of the predetermined cycle.

### CROSS-REFERENCE TO RELATED APPLICATION

This application claims the priority benefit of Japan application serial no. 2025-030187, filed on Feb. 27, 2025. The entirety of the above-mentioned patent application is hereby incorporated by reference herein and made a part of this specification.

### SUMMARY

### Technical Field

The disclosure relates to a light-emitting diode (LED) drive control device that drives an LED device and a control circuit for driving an LED device.

### Description of Related Art

Recently, an LED device is used in a display unit of a display device and a backlight of a liquid crystal display device, and the brightnesses of multiple LED devices are individually controlled.

For example, the display devices include self-luminous displays that use LED devices as display elements, and liquid crystal display devices that adopt local dimming for individually controlling LED backlights.

Pulse width modulation type (PWM-type) devices are widely used as the drive devices of conventional LED devices. In PWM-type LED drive control devices, for example, as shown in Patent Document 1 (Japanese Patent Application Laid-open No. 2013-156326), a drive signal (PWM pulse) in which the pulse width is modulated corresponding to the brightness value of the video signal is generated for each frame period of the video signal. By applying a voltage to the LED device according to the generated drive signal, a light-emitting period and a non-emitting period of the LED device occur within one frame period, and as a result, the luminous brightness of the LED device for each frame can be made to correspond to the brightness value of the video signal.

An LED drive control device that controls a brightness of an LED device based on dimming data at each predetermined cycle is provided. The LED drive control device includes: an ideal clock setting unit, setting a first clock pulse count corresponding to a maximum value that the dimming data is able to take; a clock generation unit, generating control clock pulses having a second clock pulse count smaller than the first clock pulse count within the predetermined cycle; a dimming correction unit, correcting the dimming data based on the first clock pulse count supplied from the ideal clock setting unit and the second clock pulse count extracted from the control clock pulses in the predetermined cycle, and outputting dimming correction data; and a drive unit, receiving the control clock pulses and the dimming correction data, and supplying a drive current to the LED device during a period of counting the control clock pulses by a number of clock pulses of the dimming correction data in each of the predetermined cycle.

### BRIEF DESCRIPTION OF THE DRAWINGS

FIG. 1 is a block diagram showing an LED drive control device of Embodiment 1.

FIG. 2 is a diagram showing multiple display regions of a display.

FIG. 3 is a diagram showing a relationship between each of multiple display regions stored in a host device in the LED drive control device of FIG. 1 and dimming data.

FIG. 4 is a time chart showing a dimming correction operation of the LED drive control device of FIG. 1.

FIG. 5 is a time chart showing a drive signal generation operation of the LED drive control device of FIG. 1.

FIG. 6 is a diagram showing duty ratio properties of a light emission period with respect to dimming data in each of the case where the frequency of a clock pulse PWMCLK is an ideal frequency and the case where the frequency of the clock pulse PWMCLK is 10% lower than the ideal frequency.

FIG. 7 is a diagram showing a light emission period for set dimming data 128 in each of the case where the frequency of the clock pulse PWMCLK is the ideal frequency and the case where the frequency of the clock pulse PWMCLK is 10% lower than the ideal frequency.

FIG. 8 is a block diagram showing an LED drive control device of Embodiment 2.

FIG. 9A is a block diagram showing a clock generation unit of the LED drive control device of FIG. 8.

FIG. 9B is a diagram showing a switching operation of a frequency switching unit of the clock generation unit of FIG. 9A.

FIG. 10 is a block diagram showing an LED drive control device of Embodiment 3.

FIG. 11 is a block diagram showing an LED drive control device of Embodiment 4.

### DETAILED DESCRIPTION

Hereinafter, an LED drive control device of the disclosure will be described in detail with reference to the drawings.

### Embodiment 1

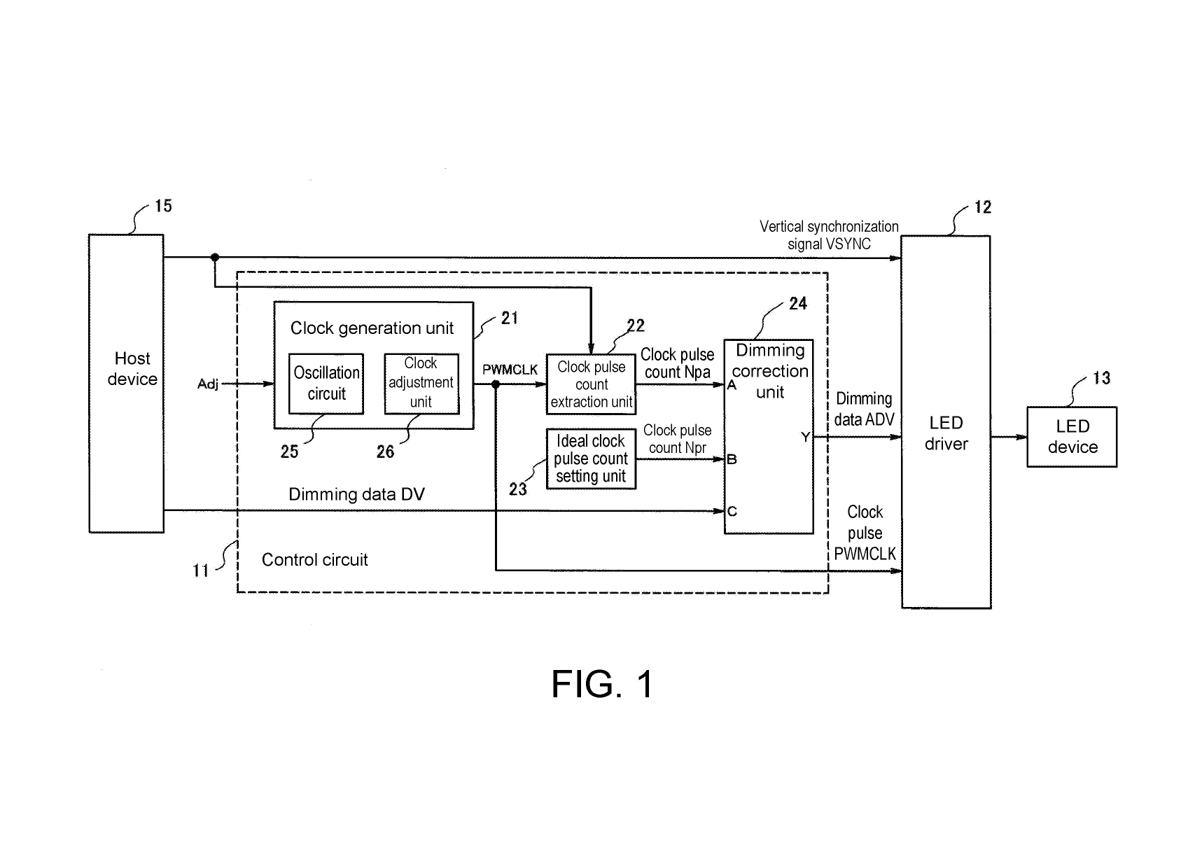

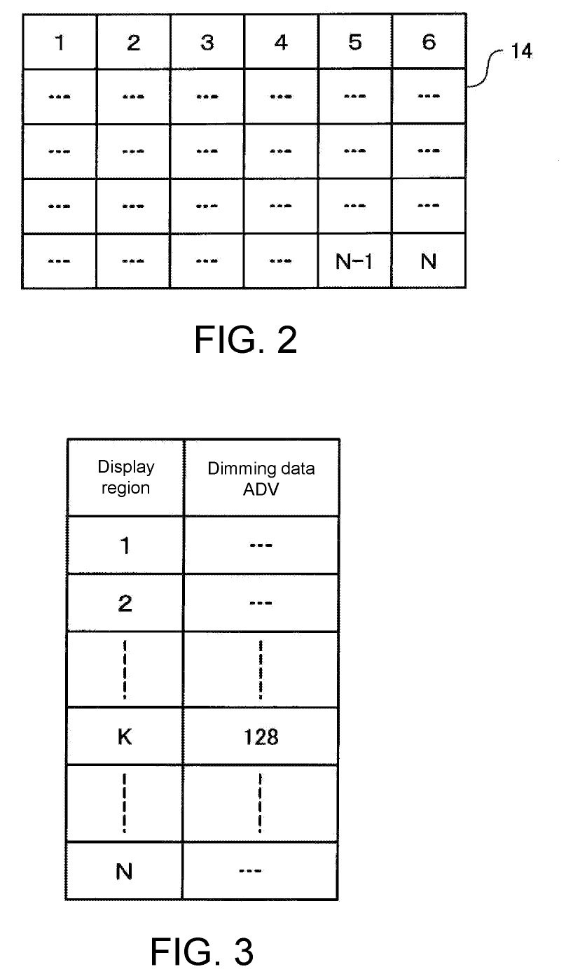

FIG. 1 shows an LED drive control device of Embodiment 1. The LED drive control device includes a control circuit 11 and an LED driver 12. The control circuit 11 is connected to the LED driver 12. The LED driver 12, which is a drive unit, drives an LED device 13 for a backlight of a display. As shown in FIG. 2, the LED device 13 includes N LEDs (not shown) corresponding to multiple display regions 1 to N of the liquid crystal display panel 14 of the display. A host device 15 is connected to the control circuit 11 and the LED driver 12, and a vertical synchronization signal VSYNC of a video signal is supplied from the host device 15 to the control circuit 11 and the LED driver 12. The LED device 13 may also exert control on all display regions with single dimming through one or more LEDs, instead of dividing the LEDs into multiple display regions 1 to N and individually exerting dimming control of the LEDs in the respective display regions. The LED device 13 may also be used for the purpose of a self-luminous display using an LED device as the display element, in addition to being used for the purpose of a backlight of a liquid crystal display unit.

As shown in FIG. 3, the host device 15 includes a memory (not shown) that stores dimming data DV indicating dimming values set for the respective display regions 1 to N of the liquid crystal display panel 14, and the dimming data DV for each of the display regions 1 to N is read out by a read control unit (not shown) every frame period. Each dimming data DV is an M-bit value representing the light emission period of each LED of the LED device 13 in one frame period, and corresponds to the luminous brightness in one frame period. In Embodiment 1, each dimming data DV is an 8-bit value and is an integer value in the range of 0 to 255. For example, dimming data DV=128 is set for the display region K. In the host device 15, the dimming data DV for each of the display regions 1 to N can be changed and set every frame period, for example. Additionally, the dimming data DV for each of the display regions 1 to N may be read out not every frame period but every multiple frame periods, such as every two frame periods.

The control circuit 11 includes a control integrated circuit (IC) and controls the drive operation of the LED driver 12. The control circuit 11 includes a clock generation unit 21, a clock pulse count extraction unit 22 (clock extraction unit), an ideal clock pulse count setting unit 23 (ideal clock setting unit), and a dimming correction unit 24.

The clock generation unit 21 generates a clock pulse PWMCLK. The clock generation unit 21 includes an oscillation circuit 25 and a clock adjustment unit 26. The oscillation circuit 25 generates an oscillation signal in response to an oscillation command Adj from the outside. The clock adjustment unit 26 receives the oscillation signal from the oscillation circuit 25 and generates the clock pulse PWMCLK based on the oscillation signal. The clock pulse PWMCLK is a pulse signal with a constant cycle (constant frequency), and the ideal pulse count of the clock pulse PWMCLK in one frame period of the video signal is 255 in this embodiment, which is the level of the maximum brightness among the brightness levels of 0 to 255 expressed in the case where M bits are, for example, 8 bits. The clock adjustment unit 26 may include a frequency divider and may have a configuration that divides the oscillation signal supplied from the oscillation circuit 25 to generate the clock pulse PWMCLK.

The clock generation unit 21 is connected to the clock pulse count extraction unit 22 and supplies the clock pulse PWMCLK to the clock pulse count extraction unit 22. Additionally, the clock generation unit 21 supplies the clock pulse PWMCLK to the LED driver 12.

The vertical synchronization signal VSYNC is supplied to the clock pulse count extraction unit 22. The clock pulse count extraction unit 22 counts the clock pulses PWMCLK every frame period of the video signal and extracts a clock pulse count Npa in one frame period. The numerical value of the clock pulse count Npa is the actual count value of the clock pulses PWMCLK generated in one frame period and corresponds to the actual frequency that is the actual frequency of the clock pulses PWMCLK.

The ideal clock pulse count setting unit 23 holds and outputs an ideal clock pulse count Npr, which is the count value of the clock pulses PWMCLK that are supposed to be generated in one frame period. The numerical value of the ideal clock pulse count Npr corresponds to a given reference frequency of the clock pulses PWMCLK. In this embodiment, the ideal clock pulse count Npr is a fixed value of 255 determined in advance. The clock pulse count Npa is made smaller than the ideal clock pulse count Npr. That is, the magnitude relationship is Npa<Npr.

The dimming correction unit 24 includes input terminals A, B, C, and an output terminal Y. The output terminal of the clock pulse count extraction unit 22 is connected to the input terminal A and the clock pulse count Npa is supplied. The output terminal of the ideal clock pulse count setting unit 23 is connected to the input terminal B, and the ideal clock pulse count Npr is supplied. The dimming data DV is supplied from the host device 15 to the input terminal C. The dimming correction unit 24 performs a calculation operation of value Y = value A / value B ×value C, where the values of the input terminals A, B, C and the output terminal Y are respectively value A, value B, value C, and value Y. That is, actual clock pulse count/ideal clock pulse count is used as a correction amount CA to be multiplied with the dimming data DV, and the resulting corrected dimming data ADV (dimming correction data) is output from the output terminal Y.

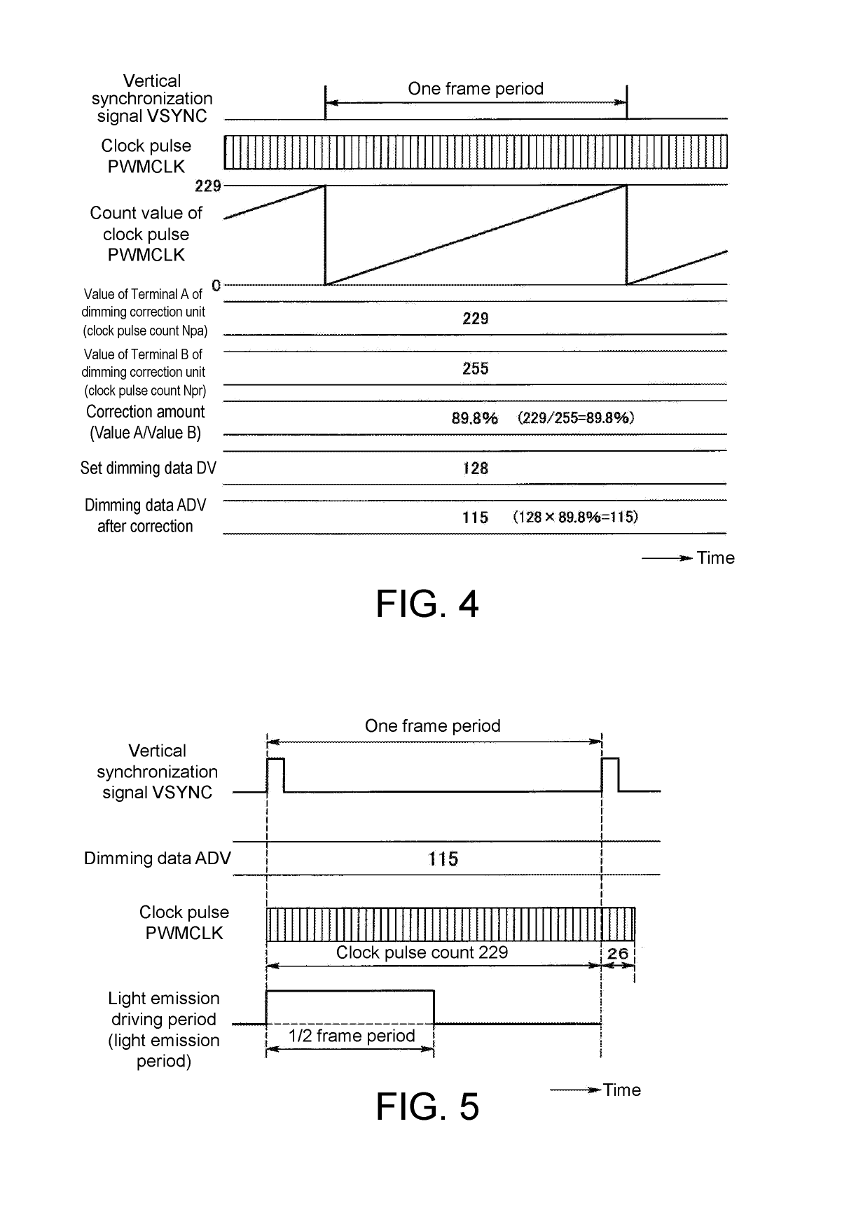

Next, the operation of the LED drive control device having such configuration will be described with reference to the time charts of FIGS. 4 and 5. To simplify the description, one display region among the multiple display regions 1 to N described above will be described, but the same operation as that performed in the one display region is performed in all of the display regions 1 to N.

As shown in FIG. 4, the vertical synchronization signal VSYNC is a pulse signal representing one frame period. The count value of the clock pulses PWMCLK by the clock pulse count extraction unit 22 increases by 1 from 0 in one frame period. In the embodiment, the clock pulses PWMCLK should ideally be repeatedly generated 255 times in one frame period, but in reality, due to a frequency error of the oscillation signal of the oscillation circuit 25, the frequency is 10% lower than the ideal frequency of the clock pulses PWMCLK, so the clock pulses are repeatedly generated 229 times in one frame period.

Therefore, the clock pulse count Npa=229 is output from the clock pulse count extraction unit 22 to the input terminal A of the dimming correction unit 24. The ideal clock pulse count Npr=255 is output from the ideal clock pulse count setting unit 23 to the input terminal B of the dimming correction unit 24. The correction amount CA for the dimming data DV is the clock pulse count Npa divided by the ideal clock pulse count Npr, so CA=229/255=89.8%.

Here, in the case where the dimming data DV supplied to the input terminal C of the dimming correction unit 24 is 128, given that the correction amount CA=89.8%, the corrected dimming data ADV becomes ADV=128×89.8%=115. The correction amount CA is obtained from the clock pulse count Npa and the ideal clock pulse count Npr, but it can also be obtained from the actual frequency and the ideal frequency (given reference frequency) of the clock pulse PWMCLK.

As shown in FIG. 5, the corrected dimming data ADV=115 is output from the output terminal Y of the dimming correction unit 24, and 115 is supplied to the LED driver 12 as is. In the LED driver 12, during a light emission period from the beginning of one frame period until the pulse count of the clock pulse PWMCLK reaches 115, the LED of the corresponding one display region among the multiple display regions 1 to N is driven for light emission. The light emission driving is executed at a duty ratio of 115/229=50.2%, and during the light emission driving period, a drive current (constant current) flows through the corresponding LED. That is, as shown in FIG. 4, the light emission driving is executed at a duty ratio of 50.2% for the actual clock pulse count Npa=229, which is 26 fewer than the ideal clock pulse count Npr=255 of the clock pulse PWMCLK in one frame period. Accordingly, it is possible to suppress the increase in the light emission period to 1% or less. The drive signal generation operation is executed for each of the display regions 1 to N in one frame period.

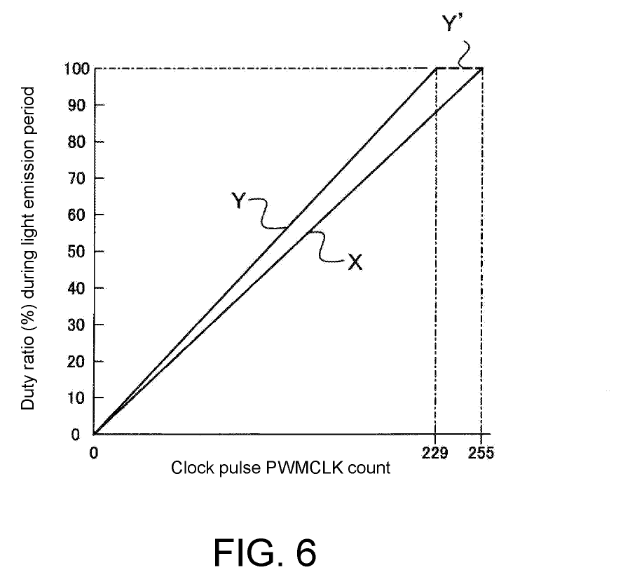

Meanwhile, as shown by the properties of a solid line X in FIG. 6, in the case where the frequency of the clock pulse PWMCLK is the ideal frequency and the clock pulse count of the clock pulse PWMCLK in one frame period is 255, which is the ideal clock pulse count Npr, light emission driving with duty ratios of 0 to 100% becomes possible for dimming data 0 to 255, so normal dimming control becomes possible. However, as shown by the properties of the solid line Y in FIG. 6, in the case where the actual frequency of the clock pulse PWMCLK is 10% lower than the ideal frequency, light emission driving with duty ratios of 0 to 100% becomes possible for dimming data 0 to 229. Also, as shown by the properties of a broken line Y' in FIG. 6, for dimming data in the range where the dimming data exceeds the value 229, it becomes the next frame period, so dimming itself becomes impossible.

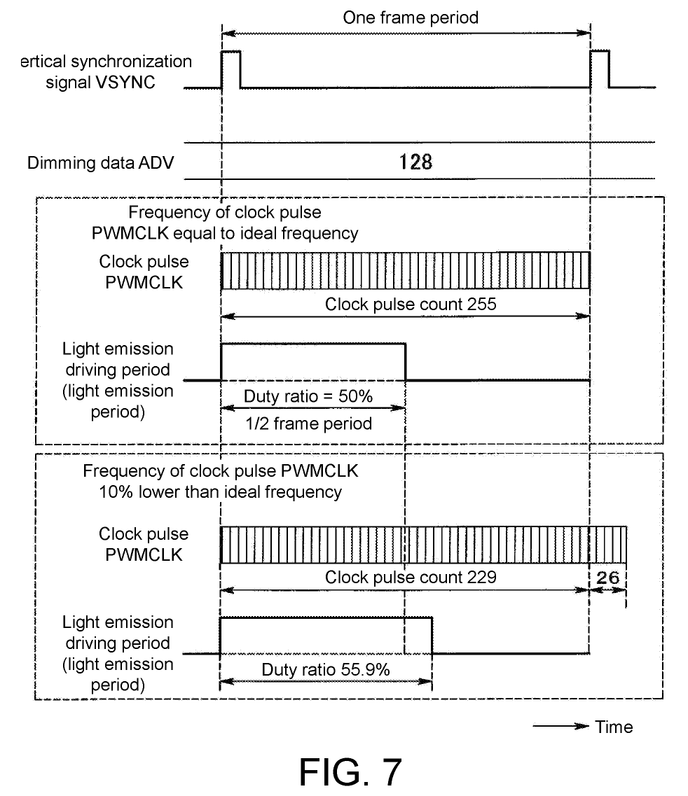

In an LED drive control device that does not include the dimming correction unit 24 shown in Embodiment 1, for example, as shown in FIG. 7, in the case where the dimming data DV for one frame period is set to 128, if the clock pulse count Npa of the clock pulse PWMCLK in one frame period is in a state of becoming the ideal clock pulse count Npr=255, a duty ratio of 50% in one frame period is set for the light emission period. On the other hand, if the clock pulse count Npa of the clock pulse PWMCLK in one frame period becomes 229 and is in a state of 10% lower than the ideal clock pulse count Npr, a duty ratio of 55.9% in one frame period becomes the light emission period.

In this way, in the case where the actual frequency of the clock pulse PWMCLK is lower than the ideal frequency, the light emission period for the dimming data of the same value increases, so normal dimming control cannot be performed. Comparatively, in the case where the actual frequency of the clock pulse PWMCLK is higher than the ideal frequency, the light emission period for the dimming data of the same value decreases, so similarly normal dimming control cannot be performed.

Comparatively, according to the LED drive control device that includes the dimming correction unit 24 as in Embodiment 1, the dimming data DV=128 becomes the corrected dimming data ADV=115 in the dimming correction unit 24, so the corrected dimming data ADV=115 is supplied to the LED driver 12. Therefore, in the LED driver 12, for example, as shown in FIG. 5, the LED of the corresponding one display region among the display regions 1 to N is driven and emits light during the light emission period from the beginning of one frame period until the clock pulse count Npa of the clock pulse PWMCLK reaches 115. The light emission driving is executed at a duty ratio of 115/229=50.2%, and the drive current flows through the corresponding LED during the light emission period. As a result, the light emission period has a duty ratio of approximately 50%, which is substantially the same as in the state where the clock pulse count Npa of the clock pulse PWMCLK in one frame period in FIG. 7 becomes the ideal clock pulse count Npr=255. Therefore, the luminous brightness corresponding to the dimming data set in advance can be obtained from the LEDs of the LED device 13, and the frequency error (deviation) from the ideal frequency (given reference frequency) of the oscillation signal of the oscillation circuit 25 can be compensated.

Such frequency error compensation from the ideal frequency of the oscillation signal of the oscillation circuit 25 conversely means that the accuracy of the frequency of the oscillation signal of the oscillation circuit 25 may be low. Additionally, the clock generation unit 21 does not need to perform frequency compensation using a phase locked loop (PLL) circuit or the like for generating the clock pulse PWMCLK. As a result, the manufacturing cost of the clock generation unit 21 including the oscillation circuit 25 can be reduced and the circuit scale can be suppressed.

### Embodiment 2

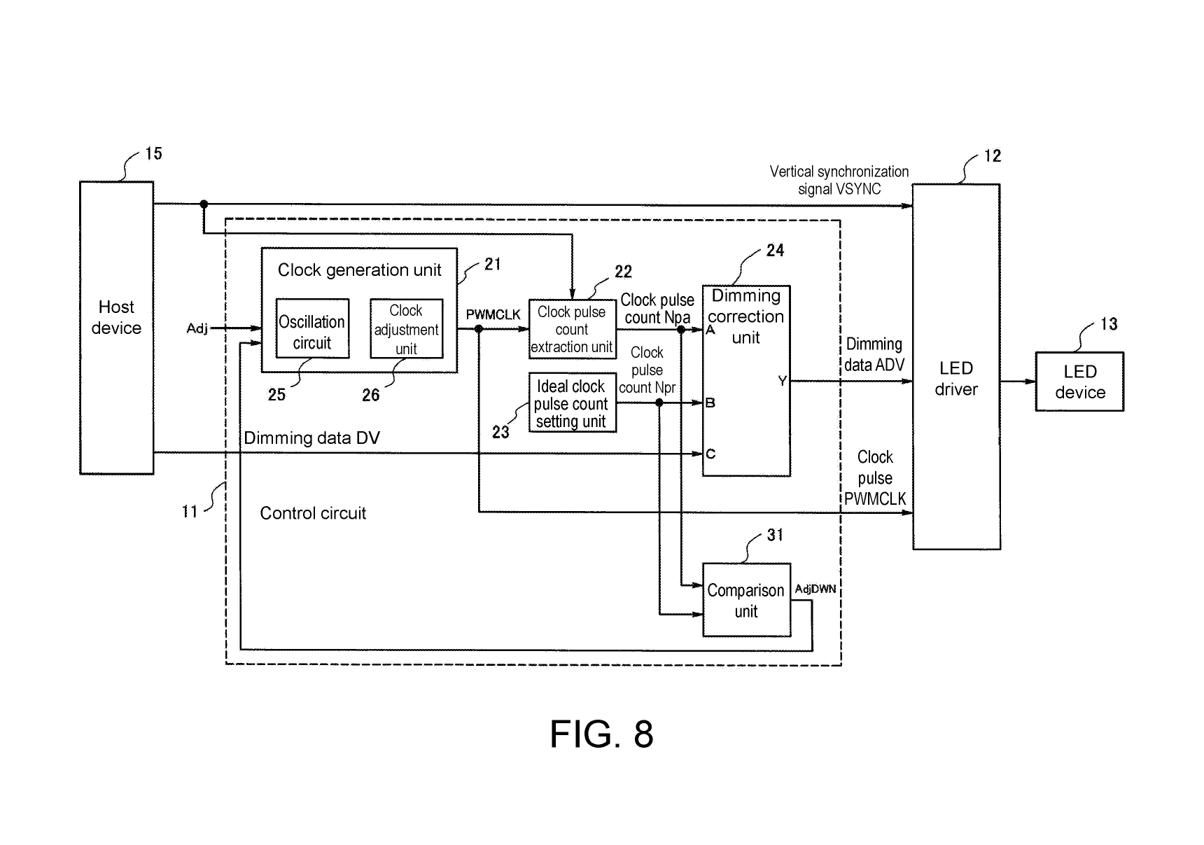

FIG. 8 shows an LED drive control device of Embodiment 2. In the LED drive control device shown in FIG. 8, a comparison unit 31 that compares the clock pulse count Npa with the ideal clock pulse count Npr is provided, and the frequency of the oscillation signal of the oscillation circuit 25 of the clock generation unit 21 is controlled to decrease according to a comparison result signal AdjDWN of the comparison unit 31. Accordingly, the frequency of the clock pulse PWMCLK is controlled so that Npa<Npr.

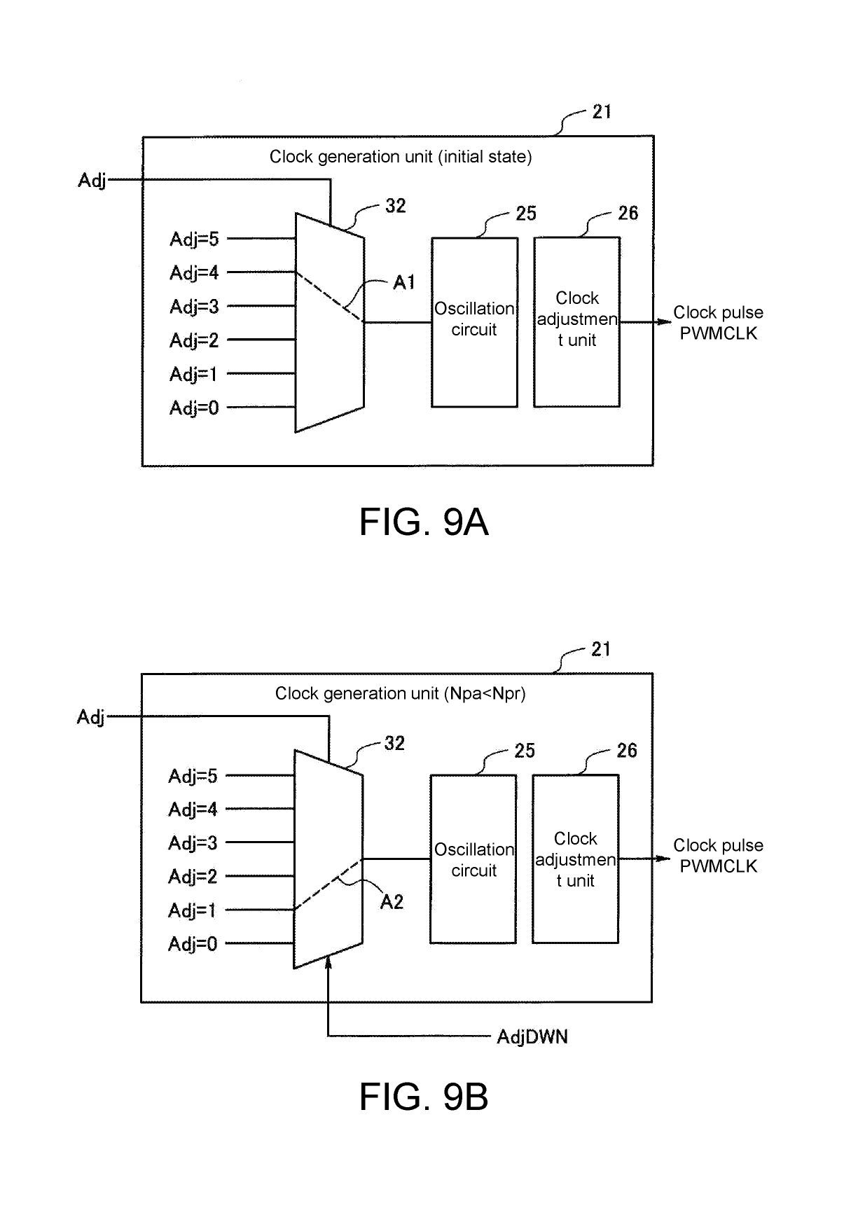

In the clock generation unit 21 of the LED drive control device shown in FIG. 8, as shown in FIG. 9A, a frequency switching unit 32 is provided at a stage preceding the oscillation circuit 25. The frequency switching unit 32 is provided with multiple setting values Adj=0 to Adj=5 for setting the frequency of the oscillation signal. One of the setting values Adj=0 to Adj=5 is selected, and the selected setting value is supplied to the oscillation circuit 25. The order of the multiple setting values Adj=0 to Adj=5 is arranged to increase the frequency of the oscillation signal of the oscillation circuit 25, and conversely, the order of Adj=5 to Adj=0 is arranged to decrease the frequency of the oscillation signal. That is, the frequency of the oscillation signal of the oscillation circuit 25 becomes the lowest when the setting value Adj=0 is selected, and the frequency of the oscillation signal of the oscillation circuit 25 becomes the highest when the setting value Adj=5 is selected.

FIG. 9A shows the selection state in an initial state, and, as shown by a broken line A1 in FIG. 9A, the frequency switching unit 32 outputs a setting value Adj=4 (predetermined setting value) that is initially set according to an oscillation command Adj from the outside to the oscillation circuit 25.

Also, the comparison result signal AdjDWN of the comparison unit 31 is supplied to the frequency switching unit 32. When the clock pulse count Npa exceeds the ideal clock pulse count Npr, that is, in the case where the magnitude relationship becomes Npa>Npr, the frequency switching unit 32 responds to the comparison result signal AdjDWN to switch the setting values Adj=0 to Adj=5 and output to the oscillation circuit 25. The switching of the setting values Adj=0 to Adj=5 is performed so that the oscillation frequency of the oscillation circuit 25 decreases. For example, as shown by a broken line A2 in FIG. 9B, the setting value Adj=1 is output to the oscillation circuit 25. Accordingly, the oscillation frequency of the oscillation circuit 25 decreases, and the frequency of the clock pulse PWMCLK also decreases. The decrease in the frequency of the clock pulse PWMCLK reduces the clock pulse count Npa of the clock pulse PWMCLK in one frame period, so the clock pulse count Npa obtained from the clock pulse count extraction unit 22 drops below the ideal clock pulse count Npr. That is, as shown in FIG. 9B, the magnitude relationship returns to Npa<Npr.

Other configurations of the LED drive control device of Embodiment 2 are the same as the LED drive control device of Embodiment 1 shown in FIG. 1, so the description thereof is omitted here.

### Embodiment 3

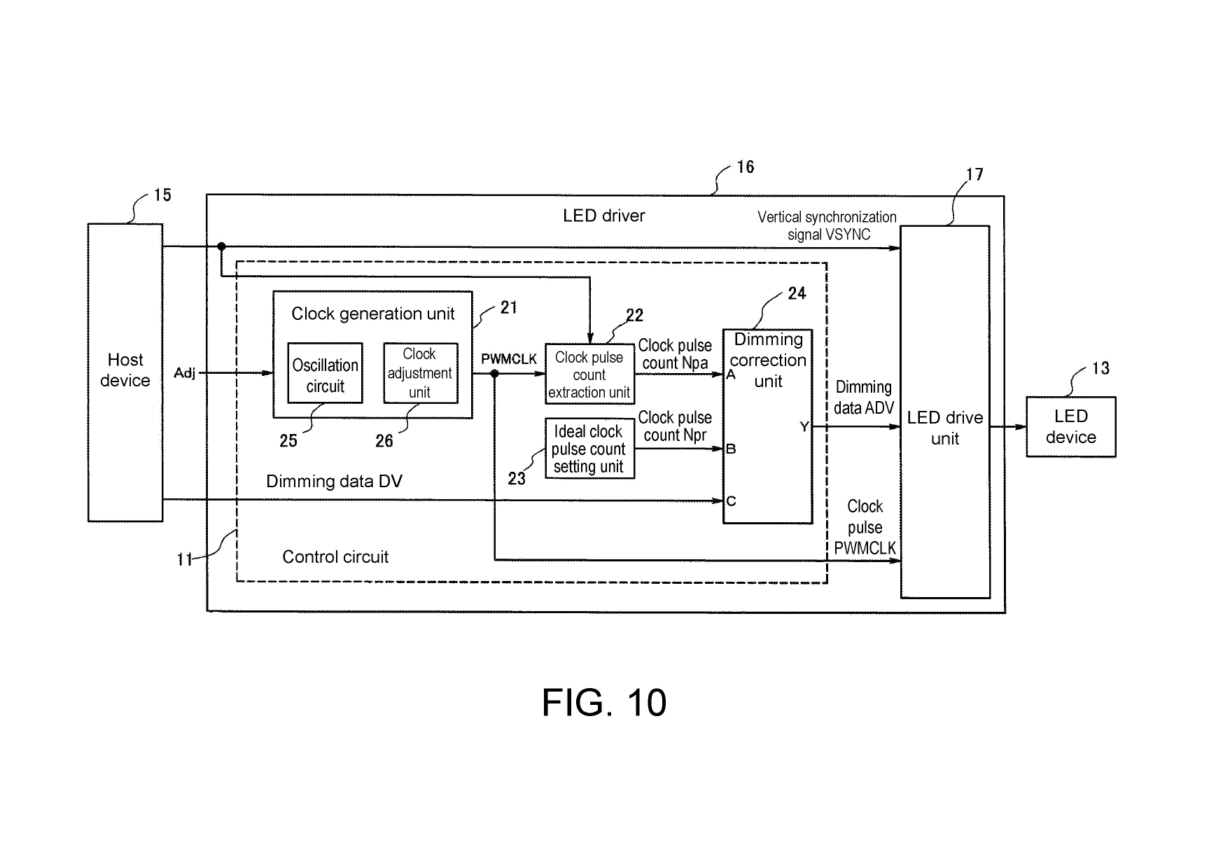

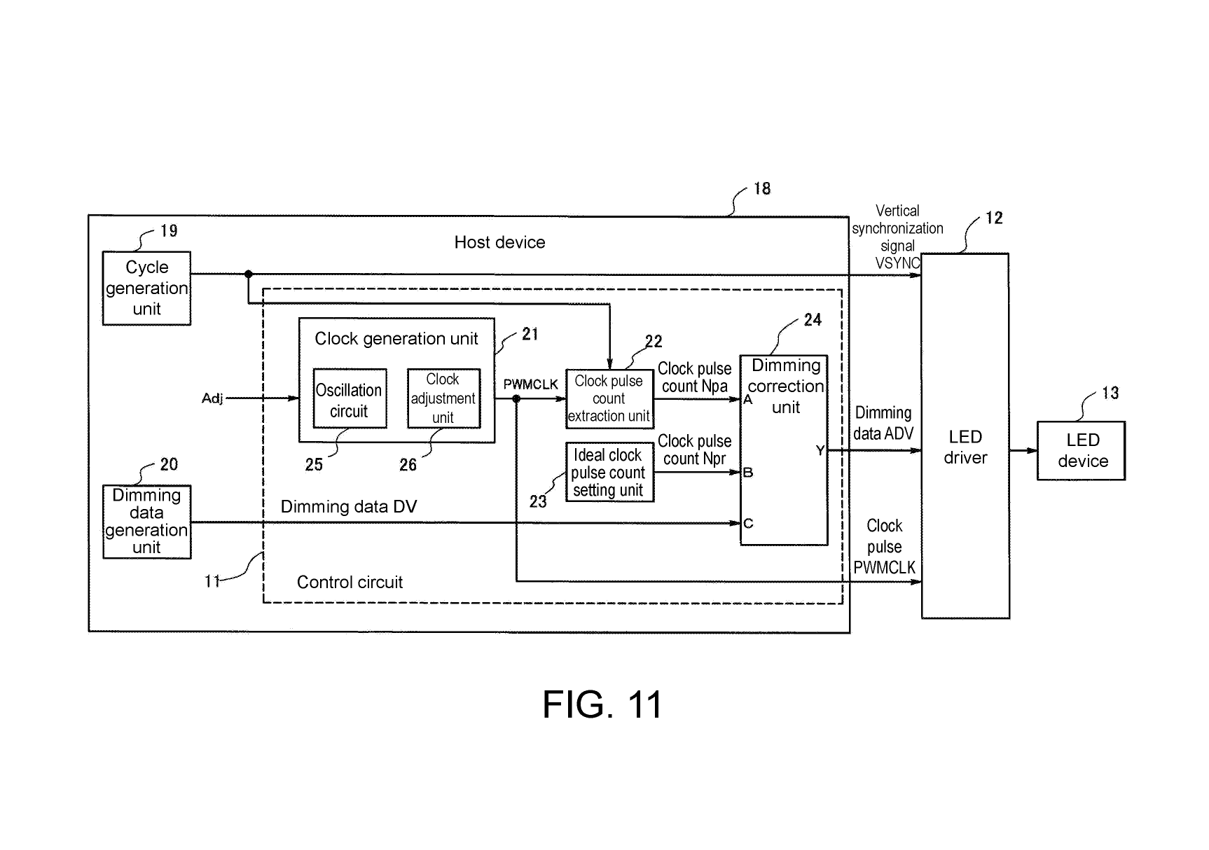

FIG. 10 shows an LED drive control device of Embodiment 3. In the LED drive control device shown in FIG. 10, an LED driver 16 includes the control circuit 11 and an LED drive unit 17. A host device 15 is connected to the LED driver 16. The control circuit 11 of the LED drive control device shown in FIG. 10 is the same as that of the LED drive control device shown in FIG. 1, and the LED drive unit 17 corresponds to the portion of the LED driver 12 of the LED drive control device shown in FIG. 1. The LED driver 16 can be configured as a semiconductor circuit that integrates the control circuit 11 and the LED drive unit 17.

Other configurations and operations of the LED drive control device shown in FIG. 10 are the same as the LED drive control device of Embodiment 1 shown in FIG. 1, so the description thereof is omitted here.

### Embodiment 4

FIG. 11 shows an LED drive control device of Embodiment 4. In the LED drive control device shown in FIG. 11, a host device 18 includes the control circuit 11, a cycle generation unit 19, and a dimming data generation unit 20. The host device 18 is connected to the LED driver 12. The control circuit 11 of the LED drive control device shown in FIG. 11 is the same as that of the LED drive control device shown in FIG. 1. The cycle generation unit 19 and the dimming data generation unit 20 are configurations included in the host device 15 shown in FIG. 1. The cycle generation unit 19 generates the vertical synchronization signal VSYNC of the video signal. The dimming data generation unit 20 generates the dimming data DV indicating dimming values. The host device 18 can be configured as a device in which the control circuit 11, the cycle generation unit 19, and the dimming data generation unit 20 are built in.

Other configurations and operations of the LED drive control device shown in FIG. 11 are the same as the LED drive control device of Embodiment 1 shown in FIG. 1, so the description thereof is omitted here.

The disclosure is not limited to the forms of the embodiments described above, and various improvements and design changes are possible within a scope that does not depart from the gist of the disclosure.

### Appendices

The following configurations are disclosed in this specification.

### Configuration 1

An LED drive control device controls a brightness of an LED device based on dimming data at each predetermined cycle. The LED drive control device includes: an ideal clock setting unit, setting a first clock pulse count corresponding to a maximum value that the dimming data is able to take; a clock generation unit, generating control clock pulses having a second clock pulse count smaller than the first clock pulse count within the predetermined cycle; a dimming correction unit, correcting the dimming data based on the first clock pulse count supplied from the ideal clock setting unit and the second clock pulse count extracted from the control clock pulses in the predetermined cycle, and outputting dimming correction data; and a drive unit, receiving the control clock pulses and the dimming correction data, and supplying a drive current to the LED device during a period of counting the control clock pulses by a number of clock pulses of the dimming correction data in each of the predetermined cycle.

### Configuration 2

The LED drive control device according to Configuration 1 includes: a clock extraction unit, receiving the control clock pulses generated by the clock generation unit, and supplying, as the second clock pulse count, a clock pulse count extracted from the control clock pulses in the predetermined cycle to the dimming correction unit.

### Configuration 3

In the LED drive control device according to Configuration 1, the dimming correction unit obtains a correction amount by dividing the second clock pulse count by the first clock pulse count, and calculates the dimming correction data by multiplying the dimming data by the correction amount.

### Configuration 4

In the LED drive control device according to Configuration 1, the clock generation unit includes: an oscillation circuit that generates a base clock having a frequency based on a predetermined setting value; and a clock adjustment unit that generates the control clock pulses based on the base clock that is generated, and the predetermined setting value is set, so that the second clock pulse count becomes smaller than the first clock pulse count corresponding to the maximum value that the dimming data is able to take.

### Configuration 5

In the LED drive control device according to Configuration 4, the clock generation unit has multiple setting values including the predetermined setting value and includes a switching means for switching the setting values, and further includes a comparison unit that compares the first clock pulse count and the second clock pulse count, and in a case where the second clock pulse count fluctuates and becomes larger than the first clock pulse count, the comparison unit supplies a signal to the clock generation unit, the signal instructing to switch to a setting value that is different from the predetermined setting value among the setting values and makes the second clock pulse count smaller than the first clock pulse count.

### Configuration 6

In the LED drive control device according to Configuration 1, the drive unit drives the LED device by a pulse width modulation method.

### Configuration 7

In the LED drive control device according to any one of Configurations 1 to 6, the predetermined cycle is set as one frame period corresponding to a rewrite time for one screen of video data in a display device.

### Configuration 8

In the LED drive control device according to Configuration 1, the LED drive control device includes multiple LED devices, and the dimming data corresponding to each of the LED devices is supplied, the dimming correction unit outputs the dimming correction data for each of the dimming data corresponding to each of the LED devices, and the drive unit supplies a current to each of the LED devices during a period of counting the control clock pulses by a clock pulse count of the dimming correction data corresponding to each predetermined cycle for each of the LED devices.

### Configuration 9

The LED drive control device according to Configuration 8 drives a display panel including, as a light emission unit, the LED devices for displaying video.

### Configuration 10

A control circuit controls a drive unit of an LED drive device that drives a panel in which an LED device is mounted and a brightness of the LED device is controlled for each predetermined cycle based on dimming data. The control circuit includes: an ideal clock setting unit, setting a first clock pulse count corresponding to a maximum value that the dimming data is able to take; a clock generation unit, generating control clock pulses in which a clock pulse count within the predetermined cycle becomes a second clock pulse count smaller than the first clock pulse count; and a dimming correction unit, correcting the dimming data based on the first clock pulse count supplied from the ideal clock setting unit and the second clock pulse count extracted from the control clock pulse in the predetermined cycle, and outputting dimming correction data. The drive unit supplies a drive current to the LED device during a period of counting the control clock pulses by a number of clock pulses of the dimming correction data in each of the predetermined cycle.

What is claimed is:

1. An LED drive control device, controlling a brightness of an LED device based on dimming data at each predetermined cycle, the LED drive control device comprising:
an ideal clock setting unit, setting a first clock pulse count corresponding to a maximum value that the dimming data is able to take;
a clock generation unit, generating control clock pulses having a second clock pulse count smaller than the first clock pulse count within the predetermined cycle;
a dimming correction unit, correcting the dimming data based on the first clock pulse count supplied from the ideal clock setting unit and the second clock pulse count extracted from the control clock pulses in the predetermined cycle, and outputting dimming correction data; and
a drive unit, receiving the control clock pulses and the dimming correction data, and supplying a drive current to the LED device during a period of counting the control clock pulses by a number of clock pulses of the dimming correction data in each of the predetermined cycle.

2. The LED drive control device as claimed in claim 1, comprising:
a clock extraction unit, receiving the control clock pulses generated by the clock generation unit, and supplying, as the second clock pulse count, a clock pulse count extracted from the control clock pulses in the predetermined cycle to the dimming correction unit.

3. The LED drive control device as claimed in claim 1, wherein the dimming correction unit obtains a correction amount by dividing the second clock pulse count by the first clock pulse count, and calculates the dimming correction data by multiplying the dimming data by the correction amount.

4. The LED drive control device as claimed in claim 1, wherein the clock generation unit comprises: an oscillation circuit that generates a base clock having a frequency based on a predetermined setting value; and a clock adjustment unit that generates the control clock pulses based on the base clock that is generated, and
the predetermined setting value is set, so that the second clock pulse count becomes smaller than the first clock pulse count corresponding to the maximum value that the dimming data is able to take.

5. The LED drive control device as claimed in claim 4, wherein the clock generation unit has a plurality of setting values comprising the predetermined setting value and comprises a switching means for switching the setting values, and further comprises a comparison unit that compares the first clock pulse count and the second clock pulse count, and
in a case where the second clock pulse count fluctuates and becomes larger than the first clock pulse count, the comparison unit supplies a signal to the clock generation unit, the signal instructing to switch to a setting value that is different from the predetermined setting value among the setting values and makes the second clock pulse count smaller than the first clock pulse count.

6. The LED drive control device as claimed in claim 1, wherein the drive unit drives the LED device by a pulse width modulation method.

7. The LED drive control device as claimed in claim 1, wherein the predetermined cycle is set as one frame period corresponding to a rewrite time for one screen of video data in a display device.

8. The LED drive control device as claimed in claim 1, wherein the LED drive control device comprises a plurality of the LED devices, and the dimming data corresponding to each of the LED devices is supplied,
the dimming correction unit outputs the dimming correction data for each of the dimming data corresponding to each of the LED devices, and
the drive unit supplies a current to each of the LED devices during a period of counting the control clock pulses by a clock pulse count of the dimming correction data corresponding to each predetermined cycle for each of the LED devices.

9. The LED drive control device as claimed in claim 8, wherein the LED drive control device drives a display panel comprising, as a light emission unit, the LED devices for displaying video.

10. A control circuit, controlling a drive unit of an LED drive device that drives a panel in which an LED device is mounted, wherein a brightness of the LED device is controlled for each predetermined cycle based on dimming data, and the control circuit comprises:
an ideal clock setting unit, setting a first clock pulse count corresponding to a maximum value that the dimming data is able to take;
a clock generation unit, generating control clock pulses in which a clock pulse count within the predetermined cycle becomes a second clock pulse count smaller than the first clock pulse count; and
a dimming correction unit, correcting the dimming data based on the first clock pulse count supplied from the ideal clock setting unit and the second clock pulse count extracted from the control clock pulse in the predetermined cycle, and outputting dimming correction data,
wherein the drive unit supplies a drive current to the LED device during a period of counting the control clock pulses by a number of clock pulses of the dimming correction data in each of the predetermined cycle.
